(19) United States
(12) Patent Application Publication
(10) Pub. No.: US 2020/0120855 A1
(43) Pub. Date: Apr. 23, 2020

(54) METHOD FOR CONTROLLING THE GERMINATION OF SEEDS AND GERMINATION DEVICE

(71) Applicant: Cinitia Anaïs PEYRARD, ST MAURICE DE CAZEVIEIELLE (FR)

(72) Inventor: Cinitia Anaïs PEYRARD, ST MAURICE DE CAZEVIEIELLE (FR)

(21) Appl. No.: 16/628,672

(22) PCT Filed: Jul. 4, 2018
(86) PCT No.: PCT/EP2018/068113

§ 371 Date: Jan. 5, 2020

(30) Foreign Application Priority Data
Jul. 4, 2017 (FR) 1756286

(51) Int. Cl. A01C 1/02; A01G 31/06

(52) U.S. Cl. CPC A01C 1/02; A01G 31/06

(57) ABSTRACT

The invention concerns a method (E) for controlling the germination of seeds in a germinator (1), said germinator (1) comprising a control unit (9) configured to implement a step consisting of determining, from ambient parameters at the germinator (1), information relative to the quantity and type of seeds to be germinated, and the respective location of same inside the chamber (17), and germination parameters specific to the germination of the seeds to be germinated in said chamber (17), control parameters for controlling the spray nozzle (5) so as to obtain, inside the chamber (17), an environment conducive to the germination of the seeds, said control parameters comprising a frequency of dispersion of the water-air mixture in the form of droplets, by the spray nozzle (5), and a frequency of dispersion of air.

### FIELD OF THE INVENTION

The invention relates to the field of germination of seeds.

More particularly, the invention is concerned with a method for controlling germination of seeds disposed in a germinator.

### TECHNOLOGICAL BACKGROUND

Consumption of germinated seeds arouses an increasing interest.

Recommended for their nutritional benefits, these vitamin-rich foods even have the advantage of being able to be produced at home. Renown of germination also urges industrialists to take a close interest in their marketing.

Whatever the production scale, germination is a natural process the control of which is delicate. Indeed, each family of seeds has needs specific thereto, especially in terms of temperature, hygrometry, and oxygenation. It is therefore necessary to be able to control the environment of the germination chamber.

Numerous germinators have thus been developed. These devices are especially based on cultivation methods such as hydroponics or aeroponics. Generally speaking, for example in horticultural devices, when plants are hydroponically grown, roots are held in an inert substrate irrigated with water and nutrients. Likewise, when plants are aeroponically grown, their roots are exposed to open air, and receive directly, by aerosol dispersion, water and nutrients necessary to their metabolism.

In most of germination devices, seeds are disposed into compartments, or trays, and are directly subjected to an aerosol dispersion, since their roots are poorly developed, in a similar way to aeroponics. These trays are arranged in a confined ventilated chamber. Seeds are humidified, permanently or at given time intervals, by means of dispersing devices spraying water as droplets. Some germinators also have additional devices for controlling oxygenation of seeds and/or temperature of the germination chamber.

Until now, however, there have not been provided germinators adapted for germinating seeds the needs of which differ from one another. Indeed, devices of prior art do not take disparities in germination temperature and hygrometry according to the type of seed into account. This can especially cause rotting or drying out of some seeds and/or non-germination of other seeds. Moreover, devices provided until now can be implemented only at a given production scale. Finally, devices of prior art require significant modifications to be able to be implemented in different climatic environments, for example between a temperate country and a tropical country.

There is therefore a need for a method for controlling germination of seeds within a germination device, of the germinator type, which enables several seed varieties to be germinated, while being able to be implemented at every production scale, and in every climatic environment.

### SUMMARY OF THE INVENTION

One object of the invention is to provide a method for controlling germination which can be implemented in germinators of any size.

Another object is to be able to germinate all the seeds suitable for consumption by means of the same control method.

Another object of the invention is to provide a method which can be implemented in simplified germinators.

Another object of the invention is to germinate seeds the health of which is improved in order to guaranty food safety for consumers.

To do so, the invention provides a method for controlling germination of seeds within a germinator, said germinator comprising: a confined chamber defined by walls, at least one removable tray extending inside the chamber, said tray being configured to accommodate seeds, a spray nozzle configured to alternately disperse in the chamber, a water-air mixture as droplets, or air only, a control unit configured to implement a step of determining, from ambient parameters in the germinator, information relating to the amount, type of seeds to be germinated, and their respective location within the chamber, and from germination parameters specific to germination of seeds to be germinated in said chamber, parameters for controlling the spray nozzle so as to obtain, in the chamber, an environment conducive to germination of seeds, said control parameters comprising a frequency of dispersion, through the spray nozzle, of the water-air mixture as droplets, and a frequency of dispersion of air.

By means of such a method, different types of seeds can germinate within a germinator chamber having an optimum environment. Indeed, the alternate frequent dispersion of a water and air mixture, and air only, enables on the one hand germinated seeds to be irrigated and oxygenated. On the other hand, this dispersion enables carbon dioxide produced by the germination process to be discharged, while mitigating heat generated by such a process. Finally, the frequency of this distribution enables the temperature to be regulated by heat exchange.

Some preferred but not limiting characteristics of the above-described method are as follows, taken alone or in combination:
the determined controlled parameters also comprise the duration of each dispersion of the water-air mixture, and of each dispersion of air, respectively,
the determined controlled parameters also comprise a setting of the spray nozzle so as to determine the size of dispersed droplets,
the germination parameters comprise temperature and hygrometry inside the chamber,
the ambient parameters in the germinator comprise the humidity density and temperature outside the germinator,
the germinator comprises several trays, and the information relating to the amount of seeds to be germinated comprises the size of the chamber, the number of trays, and the surface area of each tray, and
it further comprises a step of controlling the germinational state of the seeds.

The invention is also concerned with a unit for controlling germination of seeds within a germinator comprising a set of modules configured to implement the steps of a previously described method for controlling germination.

Finally, the invention is concerned with a device for germinating seeds, or germinator, comprising: a confined chamber defined by walls, at least one removable tray extending inside the chamber, said tray being configured to accommodate seeds, a spray nozzle configured to alternately disperse in the chamber, a water-air mixture as droplets, or air only, and a control unit such as previously described.

Some preferred but not limiting characteristics of the above-described device for germinating seeds are as follows: the device further comprises an air supply circuit, a water supply circuit, the spray nozzle being connected on the one hand to the air supply circuit, and on the other hand to the water supply circuit, the nozzle being disposed so that a portion of the nozzle extends within the chamber and so as to alternately disperse an air-water mixture, or air only, at the upper surface of the receptacle space of the tray.

### BRIEF DESCRIPTION OF THE DRAWINGS

Further characteristics, purposes and advantages of the present invention will better appear upon reading the detailed description that follows, and with regard to the appended drawings given by way of non-limiting examples and in which:

FIG. 1 is a schematic view of an exemplary embodiment of a germinator within which an exemplary embodiment of the method for controlling germination according to the invention can be implemented;

FIG. 2 schematically illustrates an exemplary embodiment of a removable tray which can be disposed within a germinator, and thus accommodate seeds to be germinated,

FIG. 3 is a schematic top view of a spray nozzle end which can extend within a germinator,

FIG. 4 is a block diagramme of an exemplary embodiment of the method for controlling germination according to the invention.

### DETAILED DESCRIPTION OF ONE EMBODIMENT

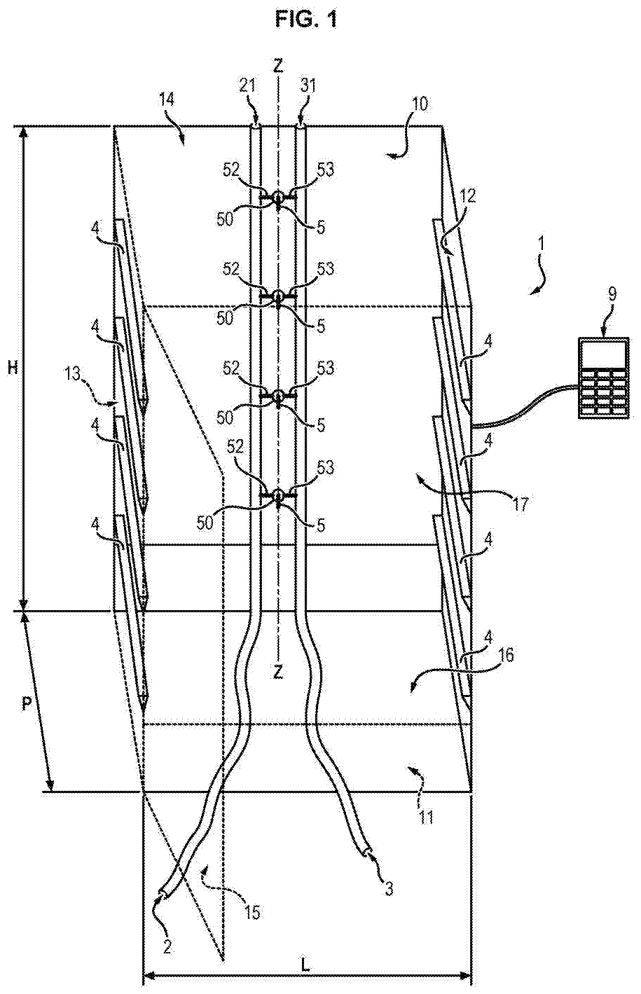

In connection with FIG. 1, a device for germinating seeds 1, or germinator, is a parallelepiped rectangle. It is fitted with a door 15, a floor 11, a ceiling 10, a right side 12, and a left side 13, and a bottom 14, which define a confined chamber 17. The volume of the germinator 1 is characterised by a height H, a depth P and a width L.

However, this is not limiting since the germinator 1 can assume any shape defining a confined chamber 17 comprising a set of walls connected to each other so as to provide an inside space, which can be accessed through an opening arranged in a wall of the chamber 17. The chamber 17 can therefore assume any shape and occupy any volume in space, according to the amount of germinated seeds to be produced and to production aimed at (home or industrial).

On each of the sides 12, 13 rails 4 extending along depth P, equidistant from each other along height H of the germinator 1 are disposed. These rails 4 are arranged in pair of rails 4 facing each other on each of the sides 12, 13. These rails 4 are configured to act as an abutment for removable trays 7 which can extend inside the germinator 1. Advantageously, as is visible for example in FIG. 1, rails 4 come as corner beads fastened to each of the sides 12, 13 of the germinator 1, at equal heights within a same pair of rails 4, and apart from each other, on a same side, by a distance equal to the height of a tray 7, to which a height depending on the height of the seeds disposed in the tray 7, once germinated, is added. By way of non-limiting example, trays 7 thus disposed on rails 4, are apart from each other by a distance between 1 and 3 cm. Even more advantageously, rails 4 can be tilted with respect to a plane orthogonal to each of the planes defined by the sides 12, 13 of the germinator 1. This slight tilting allows easier percolation of water for irrigating seeds through gravity. Optionally, rail 4 disposed closest to the bottom 10 is located at such a distance from said bottom 10 that a tank-forming space 16 is provided to accommodate percolating water when the seeds disposed in the trays are irrigated. Advantageously, water having irrigated a given tray 7 directly percolates towards the tank 16, without passing through the trays 7 lower than the given tray 7. This water is then discharged by means configured therefor, to prevent the atmosphere contained inside the chamber 17 from being polluted. This guaranties an optimum health of the seeds, and improves food safety for consumers. Indeed, water having irrigated the seeds of the given tray 7 is loaded with enzymes unsuitable for human digestion. Generally speaking, the inside of the chamber 17 is structured so as to optimise space occupied by the trays 7, as well as the amount of seeds to be produced.

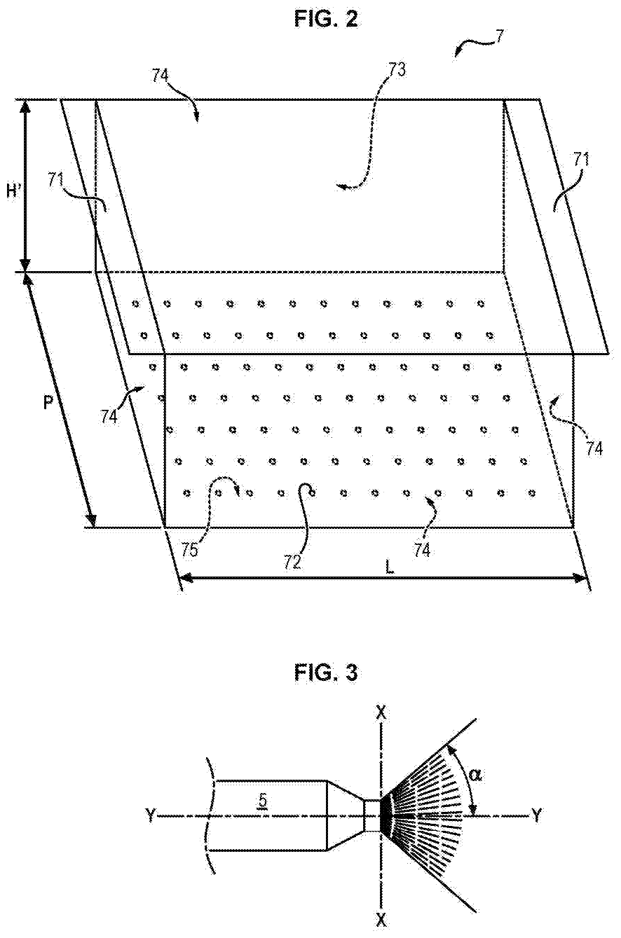

As illustrated in FIG. 2, each tray 7 is also of a parallelepiped rectangle shape and has the same depth P, and same width L as the germinator 1. It nevertheless has a height H′ lower than H. Advantageously, the trays 7 all have the same height H′ fulfilling determined standardisation criteria. It comprises a bottom wall 75 drilled with multiple openings 72 of sufficiently small dimensions to prevent the seeds from escaping or the roots from growing, but sufficiently wide to allow discharge of irrigation water. It also comprises rims 74 defining, with the bottom wall 75, a receptacle 73 configured to accommodate seeds to be germinated. Each tray comprises two tabs 71 extending from the ends of the rims 74 extending along the depth P. These tabs are configured to cooperate with the rails 4 of the germinator 1 to act as an abutment for the trays 7.

Alternatively, trays 7 can assume any three-dimensional shape enabling the trays 7 to extend inside the chamber 17. In any case, the trays 7 comprise a bottom 75 and rims 74 so as to provide a receptacle 73 to accommodate seeds to be germinated. Generally speaking, the number, shape, and disposition of trays 7 inside the germinator 1 depend on the type of seed used and on the amount of germinated seeds desired to be produced. Advantageously, each of the trays 7 receives one or more given types of seeds.

As is visible in FIG. 1, the door 15 is able to pivot on a system of hinges, for example a set of hinge pins, fastened to either side of the germinator 1. In an open position, the door 15 allows access inside the chamber 17, for example to remove or dispose trays 7 inside the chamber 17. In a closed position, the door 15 provides confinement of the chamber 17. Advantageously, a wall 15, for example the door 15, can comprise a translucent material, so as to enable inside of the chamber 17 to be observed. This characteristic can especially prove to be useful in a method for controlling E germination of seeds, in order to ensure that all the seeds germinate, without any of them rotting.

A set of openings 50 is provided in the bottom 14. Spray nozzles 5 extend through these openings so as to open into the chamber 17. Advantageously, all the openings 50 are aligned along an axis Z-Z which extends along the height parallel to the ridges of the bottom 14. Openings 50 are each made at a slightly higher height from the floor than a pair of rails 4 to which they respectively correspond. In a favoured manner, the bottom of the germinator 1 has as many openings 50 as there are pair of rails 4 able to receive a tray 7.

As is visible in FIG. 3, in operation, a nozzle 5 alternatively disperses a water/air mixture as micro-droplets or air only in a direction Y-Y substantially orthogonal to axis Z-Z. By micro-droplets, it is understood that particles forming the air-water mixture have a size typically in the order of one micrometre. Furthermore, a dispersion beam opens along an opening angle a configured for the dispersed droplets or air to cover the whole upper surface of the receptacle 73 of the tray 7 being under the nozzle 5. Advantageously, the opening angle a is between 0° and 90°, preferably between 30° and 60°, and is for example 45°. Optionally, the head of nozzle 5 has a substantially conical shape, revolving about axis Y-Y. Advantageously, each opening 50 is made at a height such that dispersion of droplets or air covers the whole upper surface of the receptacle of the tray 7 located under the opening 50. The operation of this type of nozzle 5, based on the Venturi effect principle, is conventional and known to those skilled in the art, and therefore will not be detailed. It is just reminded that the advantage of a spray nozzle 5 is to be able to alternately disperse an air/water mixture or air only in a drivable manner.

Again with reference to FIG. 1, each nozzle 5 is respectively connected 52, 53 to an air supply circuit 2, and to a water supply circuit 3. These circuits 2, 3 can operate in a closed loop, or in an open loop, on electrical or non-electrical supply systems, which are common or independent of one another, according to the user's needs and capabilities. Moreover, the water supply circuit 3 can comprise a device for circulating nutrients necessary to the seed growth. In any case, each of these circuits 2, 3 has a duct 21, 31 extending outside the germinator 1 suitable for running water or air. As is visible in FIG. 1, these circuits for example each comprise a channel 21, 31 disposed outside the chamber 17, against the bottom 14, and extend parallel to axis Z-Z. Each nozzle 5 is thereby bypass-connected to the ducts 2, 3 from which it is possible to extract water or air.

The air supply circuit 2 can advantageously be connected to a compressor (not represented). The water supply circuit 3 can in turn be connected to a water source (not represented).

Advantageously, the germinator 1 includes one or more sensor(s) (not represented) configured to provide information relating to the temperature and/or hydrometry and/or hygrometry and/or oxygenation inside the chamber of the germinator 1. Alternatively, the temperature and/or hydrometry and/or hygrometry and/or oxygenation inside the chamber of the germinator 1 are supplied by a model having weather data for the production site.

Optionally, the germinator 1 comprises a drivable or not drivable ventilating system, configured to change all or part of the air inside the chamber 17.

In any case, the germinator is connected to a control unit 9 comprising a set of modules configured to implement a method for controlling E germination of seeds within the germinator 1. Advantageously, this control unit comprises a memory adapted to load a set of parameters, for example control parameters used by the control method E.

Germination is a complex natural process affecting every seed family. By “seed”, it is meant any type of plant ovule from which a plant can be grown. This development stage of a plant concerns seeds disposed in an adequate environment (especially in terms of temperature and hygrometry), especially consumes water and oxygen, and produces heat and carbon dioxide.

Each type of seed has different properties and a different germination environment. Water and oxygen supply, and heat and carbon dioxide discharge are essential parameters in controlling germination. Indeed, a poor discharge of carbon dioxide or heat produced by a type of seed can cause rotting and smothering of another type of seed, the germination of which is for example slower than the first type. Likewise, an irrigation and oxygenation rate of a type of seed can cause rotting or death of other types of seeds a germination process of which would for example need less water and less air.

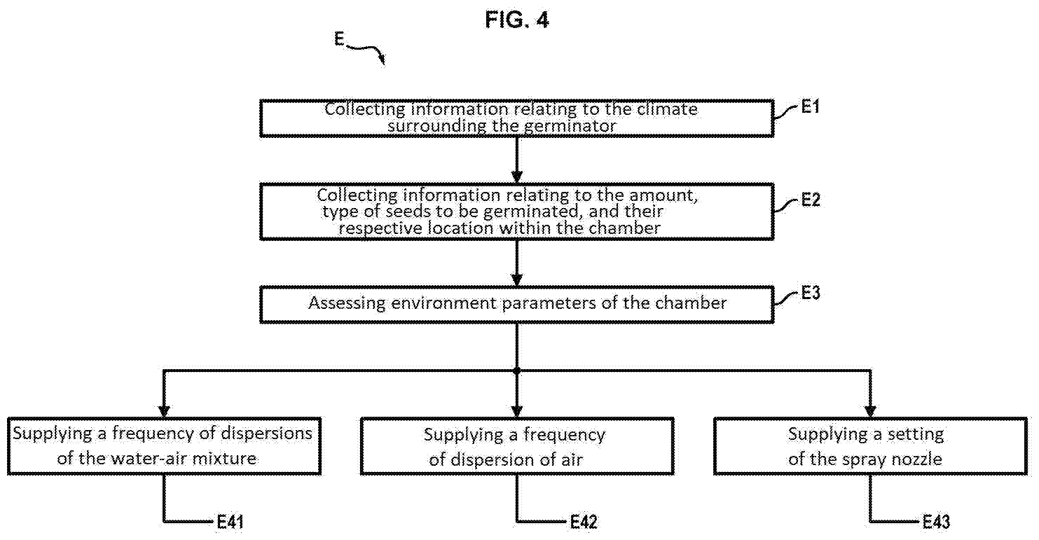

With reference to FIG. 4, an embodiment of a method for controlling E germination of seeds within a germinator 1 such as previously described will now be described in further detail.

Such a control method consists in determining parameters for controlling the spray nozzle 5 so as to obtain, in the chamber 17 of the germinator 1, an environment conducive to germination of seeds.

This determination is implemented by the control unit 9 from a set of parameters among which: ambient parameters in the germinator 1, information relating to the amount and type of seed to be germinated, as well as their respective location within the chamber 17, and germination parameters specific to germination of seeds to be germinated in the chamber 17.

Control parameters are determined from ambient parameters in the germinator since the chamber 17 of the germinator 1 is confined, but however not fully hermetically sealed. The knowledge E1 of ambient parameters in the germinator 1 is then essential for the control quality of germination. Indeed, the surrounding climate influences the germination process. In this respect, seeds produced in a home environment will have different germination properties from seeds produced in an industrial environment, for example an outdoor warehouse. The same applies for seeds produced in a tropical environment with respect to seeds produced in a temperate environment. For example, the applicant has noticed that the air dispersion frequency in a tropical environment had to be higher than that in a temperate environment in order to discharge excess heat related to the atmosphere surrounding the germinator. Advantageously, the ambient parameters in the germinator 1 comprise a degree of humidity of the atmosphere within which the germinator 1 is placed, as well as the temperature surrounding the germinator 1. This temperature can be supplied E1 by sensors disposed outside the germinator 1, and configured in this respect or, as an alternative, supplied E1 by a weather model.

The amount, type of seeds to be germinated, and their respective location within the chamber 17 of the germinator 1 are essential parameters for optimizing the environment inside the chamber. Convection movements of more or less humidity laden hot air inside the chamber 17, can for example influence the environment within the chamber 17. Depending on the location, the amount and type of seeds to be germinated, the optimum germination environment will change. It is therefore necessary to adapt the parameters for controlling the nozzle 5 accordingly. Information relating to the amount, type of seeds to be germinated, and their respective location within the chamber of the germinator, can be directly supplied by the user E2 at the beginning of the germination cycle. Alternatively, the amount of seeds produced is assessed E2 by the control unit 9 from the size of the chamber 17, the number of trays 7 and the surface area of each tray 7.

The germination parameters specific to germination of seeds to be germinated in the chamber 17 are parameters directly affecting the germination process. Their monitoring influences control of spray nozzle 5 in order to permanently ensure an environment conducive to all types of seeds. In this respect, such germination parameters comprise temperature and hygrometry inside the chamber 17. In a favoured embodiment of the control method E, it is not necessary to know at any time the temperature inside the chamber 17. The method E involves keeping a temperature inside the chamber 17 from a given temperature, for example outdoor temperature, which can be supplied by the user, or pre-recorded. Alternatively, the control method E involves having information relating to the temperature within the chamber.

Determining parameters for controlling the nozzle 5 is made empirically. In this respect, the control method E can involve a step of visually controlling the seeds. This step can be implemented by an outsourcer or any professional authorised to handle the germinator 1 in accordance with health regulations. This step is used to validate the control method E, and if need be can result in modifying the control parameters. The visual control can be made directly, or by means of a video recording device, such as for example a camera, disposed outside or inside the chamber 17, so as to provide images of the germinating seed in real time. Alternatively, the control parameters can be pre-recorded or pre-loaded within the memory of the control unit 9.

The parameters for controlling the nozzle 5 enable the control unit 9 to drive the behaviour of nozzles 5 in order to ensure E3 an optimum germination environment for each of the type of seeds disposed in the chamber 17 of the germinator 1. It is indeed necessary to control the temperature at each of the production trays 7, but also oxygenation of seeds and dissipation of carbon dioxide and heat produced.

In this respect, the control unit 9 determines control parameters comprising a frequency of dispersion E41, through the spray nozzle 5, of the water-air mixture as droplets, and a frequency of dispersion of air E42, the duration of each dispersion of the water-air mixture, and of each dispersion of air, respectively, and a setting E43 of the spray nozzle 5 so as to determine the size of droplets dispersed. This setting can comprise determining the size and/or shape of the spray nozzle 5, as well as the air and water pressure and flowrate in the supply circuit 2, 3 of spray nozzles 5.

In order to regulate temperature, water is dispersed by short pulses, at a frequency determined by the control unit 9 from determined control parameters, and as sufficiently thin droplets. To do so, water is mixed with air inside the spray nozzle 5. Advantageously, the conical head of the nozzle 5 enables the water-air mixture at the output of nozzle 5 to be accelerated, which allows formation of mist of dispersed droplets. Partial vaporisation of droplets enables heat released by the germination process to be collected and, at any time, the ideal local temperature for seeds to be kept. In this respect, controlling thinness of droplets enables performance and quickness of the heat exchange to be affected. This characteristic makes it possible to dispense with the necessary of having a device for regulating temperature in addition to the irrigation device, as is usual in germinators of prior art. Indeed, the irrigation device, namely spray nozzles 5, provides both functions. Moreover, the thinness of droplets allows a more efficient absorption of dispersed particles by the roots of germinated seeds. This is the reason why setting the spray nozzle so as to determine the size of dispersed droplets influences the quality of the environment within the chamber.

Dispersion of air only allows an optimum oxygenation of germinated seeds, but also the discharge of carbon dioxide produced during germination. The frequency and duration of these dispersions are therefore to be provided to ensure optimum environment of hygrometry for the seeds, and prevent some of them from rotting, or others from not germinating. Advantageously, it will be seen to it that the dispersion frequency is the highest possible, relative to the amount of seeds to be germinated, so as to permanently control the germination environment. The alternate dispersion between water-air mixture and air alone ensures an optimum germination environment.

1. A method for controlling germination of seeds within a germinator, said germinator comprising: a confined chamber defined by walls, at least one removable tray extending inside the chamber, said tray being configured to accommodate seeds, a spray nozzle configured to alternately disperse in the chamber, a water-air mixture as droplets, or air only, a control unit configured to implement a step of determining, from ambient parameters in the germinator, information relating to the amount, type of seeds to be germinated, and their respective location within the chamber, and from germination parameters specific to germination of seeds to be germinated in said chamber, parameters for controlling the spray nozzle so as to obtain, in the chamber, an environment conducive to germination of seeds, said controlled parameters comprising a frequency of dispersion, through the spray nozzle, the water-air mixture as droplets, and a frequency of dispersion of air.

2. The method according to claim 1, wherein, the determined controlled parameters also comprise the duration of each dispersion of the water-air mixture, and of each dispersion of air, respectively.

3. The method according to claim 1, wherein the determined controlled parameters also comprise a setting of the spray nozzle so as to determine the size of dispersed droplets.

4. The method according to claim 1, wherein the germination parameters comprise the temperature and hygrometry inside the chamber.

5. The method according to claim 1, wherein the ambient parameters in the germinator comprise a humidity density and temperature outside the germinator.

6. The method according to claim 1, wherein the germinator comprises several trays, and the information relating to the amount of seeds to be germinated comprises the size of the chamber, the number of trays and the surface area of each tray.

7. The method according to claim 1, further comprising a step of controlling the germination state of the seeds.

8. A unit for controlling germination of seeds within a germinator comprising: a confined chamber defined by walls, at least one removable tray extending inside the chamber, and for accommodating seeds, and a spray nozzle configured to alternately disperse, a water-air mixture as droplets, or air only, the control unit further comprises a set of modules configured to implement the step of the control method according to claim 1.

9. A device for germinating seeds, or a germinator, comprising a confined chamber defined by walls, at least one removable tray extending inside the chamber, said tray being configured to accommodate seeds, a spray nozzle configured to alternately disperse in the chamber, a water-air mixture as droplets, or air only, and a control unit according to claim 8.

10. A device for germinating seeds according to claim 9, further comprising: an air supply circuit, a water supply circuit, the spray nozzle being connected on the one hand to the air supply circuit, and on the other hand to the water supply circuit, the nozzle being disposed so that a portion of the nozzle extends within the chamber and so as to alternately disperse an air-water mixture, or air only, at the upper surface of the receptacle space of the tray.
